(19) United States
(12) Patent Application Publication
(10) Pub. No.: US 2015/0193613 A1
(43) Pub. Date: Jul. 9, 2015

(54) PORTABLE APPARATUS AND METHOD OF CONNECTING TO EXTERNAL APPARATUS

(71) Applicant: SAMSUNG ELECTRONICS CO., LTD., Suwon-si (KR)

(72) Inventors: Yoon-su KIM, Seoul (KR); Jung-joo SOHN, Seoul (KR); Keum-koo LEE, Yongin-si (KR); Young-kyu JIN, Seoul (KR); Yong-gook PARK, Yongin-si (KR); Jeong-eun LEE, Seongnam-si (KR)

(73) Assignee: SAMSUNG ELECTRONICS CO., LTD., Suwon-si (KR)

(21) Appl. No.: 14/659,076

(22) Filed: Mar. 16, 2015

Related U.S. Application Data
(63) Continuation-in-part of application No. 14/227,541, filed on Mar. 27, 2014.
(60) Provisional application No. 61/805,632, filed on Mar. 27, 2013.

(30) Foreign Application Priority Data
Jul. 11, 2013 (KR) 10-2013-0081785

(51) Int. Cl. G06F 21/36; H04W 12/08

(52) U.S. Cl. CPC G06F 21/36; H04W 12/08

(57) ABSTRACT

Provided are a portable apparatus and a method of connecting the portable apparatus to an external apparatus. The portable apparatus includes a communicator, a storage configured to store a connection unlock pattern and an external apparatus connection information, a touchscreen configured to display a lock screen; and a controller configured to control communicator, the storage, and the touchscreen. The controller is configured to unlock the lock screen by detecting the connection unlock pattern that is input to the lock screen, and connects the portable apparatus to the external apparatus via the communicator by using the connection unlock pattern and the external apparatus connection information.

### CROSS REFERENCE TO RELATED APPLICATIONS

This application is a Continuation in Part of U.S. application Ser. No. 14/227,541, filed on Mar. 27, 2014, which claims priority from U.S. Provisional Application No. 61/805,632, filed on Mar. 27, 2013, in the U.S. Patent and Trademark Office, and Korean Patent Application No. 10-2013-0081785, filed on Jul. 11, 2013, in the Korean Intellectual Property Office, the disclosures of which are incorporated herein in their entireties by reference.

### BACKGROUND

1. Field

Apparatuses and methods consistent with the exemplary embodiments relate to a portable apparatus and a method of connecting to an external apparatus, in which the method performed by the portable apparatus. More particularly, apparatuses and methods consistent with the exemplary embodiments relate to a portable apparatus capable of connecting, by using a connection unlock pattern that is input to a lock screen, to an external apparatus that corresponds to the connection unlock pattern, and a method of connecting to the external apparatus, in which the method performed by the portable apparatus.

2. Description of the Related Art

Recently, portable apparatuses have become capable of providing various services and functions that can be multitasked. Also, various security methods are being developed in order to protect a plurality of pieces of contents that are executed or are stored in the portable apparatuses.

In response to a lock screen being displayed on the portable apparatus, a user has to input an unlock pattern or a password in order to unlock the lock screen. If a security function is applied to an application, the user has to input a password or the like so as to unlock the security function of the application. Also, if the portable apparatus is connected to a neighboring external apparatus, the portable apparatus has to go through a complicated connection procedure in order to connect with the external apparatus.

### SUMMARY

Additional aspects will be set forth in part in the description which follows and, in part, will be apparent from the description, or may be learned by practice of the exemplary embodiments.

According to an aspect of an exemplary embodiment, a method of connecting to an external apparatus, includes operations of displaying, by the portable apparatus, a lock screen; detecting a connection unlock pattern that is input to the lock screen; and connecting the portable apparatus to the external apparatus that corresponds to the connection unlock pattern that is input, wherein the connection unlock pattern is different from an unlock pattern for unlocking the lock screen.

The method may further include an operation of transmitting content to the external apparatus in response to the portable apparatus being connected to the external apparatus.

According to one or more exemplary embodiments, a method of connecting a portable apparatus to an external apparatus, in which the method is performed by the portable apparatus, includes operations of displaying, by the portable apparatus, a lock screen; receiving one of a connection unlock pattern and a unlock pattern, which is input to the lock screen; and in response to the connection unlock pattern being received, connecting the portable apparatus to the external apparatus that corresponds to the connection unlock pattern, and in response to the unlock pattern being received, unlocking the lock screen.

According to one or more exemplary embodiments, a portable apparatus includes a communicator; a storage configured to store a connection unlock pattern and an external apparatus connection information including information about an external apparatus that is connected to the portable apparatus which corresponds to the connection unlock pattern; a touchscreen configured to display a lock screen; and a controller configured to control the communicator, the storage, and the touchscreen, wherein the controller is configured to unlock the lock screen by detecting the connection unlock pattern that is input to the lock screen, and connect the portable apparatus to the external apparatus via the communicator by using the connection unlock pattern and the external apparatus connection information.

According to one or more exemplary embodiments, an external apparatus includes a communicator configured to connect to a portable apparatus; a display; and a controller configured to control the communicator and the display, wherein the controller is configured to control the display to display content received from the portable apparatus which is connected to the external apparatus by using the communicator.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 illustrates a connection between a portable apparatus and an external apparatus, according to an exemplary embodiment;

FIG. 2 is a block diagram of the portable apparatus and the external apparatus, according to another exemplary embodiment;

FIG. 3 is a flowchart of a method of connecting a portable apparatus to an external apparatus, in which the method performed by the portable apparatus, according to an exemplary embodiment;

FIG. 4 is a flowchart illustrating in detail an operation of registering a connection unlock pattern, shown in FIG. 3, according to an exemplary embodiment;

FIGS. 5A through 5G illustrate examples of a screen of the portable apparatus, according to exemplary embodiments; and

FIGS. 6A through 6H illustrate an example in which the portable apparatus registers the external apparatus, according to an exemplary embodiment.

### DETAILED DESCRIPTION

Reference will now be made in detail to exemplary embodiments, examples of which are illustrated in the accompanying drawings, wherein like reference numerals or signs refer to like parts or elements that perform substantially the same functions.

While terms “first” and “second” are used to describe various components, the components are not limited to the terms “first” and “second”. The terms “first” and “second” are used only to distinguish between each component. For example, a first component may indicate a second component or a second component may indicate a first component without conflicting with the inventive concept. As used herein, the term “and/or” includes any and all combinations of one or more of the associated listed items.

Throughout the specification, the term “application” means software that is executed in a computer operating system (OS) or a mobile OS and is used by a user. For example, the application may include a word processor application, a spread sheet application, a contacts application, a calendar application, a memo application, an alarm application, a social network service (SNS) application, a chatting application, a map application, a music player, or a video player. In one or more exemplary embodiments, the application may mean software that is executed in a portable apparatus or an external apparatus (e.g., a server, etc.) connected in a wireless or wired manner with the portable apparatus. Also, in one or more exemplary embodiments, the application may mean software that is executed in the portable apparatus in response to a received user input.

Throughout the specification, “content” may be displayed on an executed application. For example, the content may include a video or audio reproduced by the video player that is one of the applications, audio reproduced by the music player, a photo displayed in a photo gallery, a web page displayed on a web browser, or the like. The content may include audio, a video, a text, an image, or a webpage that is displayed or executed in the application. The content may include audio, a video, a text, an image, or a webpage that is executed according to a user input (e.g., a touch, etc.). The content may include a screen of the executed application. Also, the content may include one item of content or a plurality of contents.

Throughout the specification, the term “widget” means a mini-application that is one of graphical user interfaces (GUIs) that support interoperation between a user and an application or an OS. For example, the widget may include a weather widget, a calculator widget, a clock widget, or the like.

Furthermore, all examples and conditional language recited herein are to be construed as being without limitation to such specifically recited examples and conditions. Throughout the specification, a singular form may include plural forms, unless there is a particular description contrary thereto. Also, terms such as “comprise” or “comprising” are used to specify the existence of a recited form, a number, a process, an operation, a component, and/or groups thereof, not excluding the existence of one or more other recited forms, one or more other numbers, one or more other processes, one or more other operations, one or more other components and/or groups thereof. Like numbers in the drawings refer to like elements that perform substantially the same functions throughout.

Expressions such as “at least one of,” when preceding a list of elements, modify the entire list of elements and do not modify the individual elements of the list.

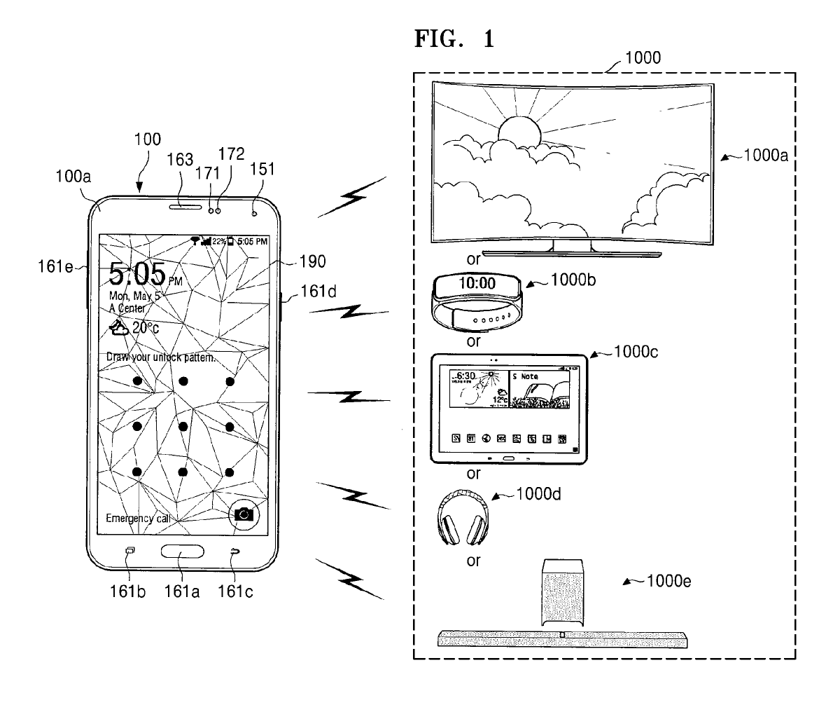

FIG. 1 illustrates a connection between a portable apparatus 100 and external apparatus 1000, according to an exemplary embodiment. For example, the portable apparatus 100 and the external apparatus 1000 may be connected in an intra-structure mode in which apparatuses are wirelessly connected to each other via an ad-hoc mode or an access point (AP). Wireless communication may include, but is not limited to, mobile communication, a wireless local area network (LAN) such as Wi-Fi, Bluetooth, Bluetooth low energy, ZigBee, Wi-Fi Direct (WFD), ultra wideband (UWB), infrared Data Association (IrDA), and Near Field Communication (NFC). Also, the portable apparatus 100 and the external apparatus 1000 may be connected to each other in a wired manner by using a connector.

The portable apparatus 100, which has a lock screen displayed on the display, may be connected to one of the external apparatuses 1000a through 1000e according to a preset connection unlock pattern that is input by a user. Also, the portable apparatus 100 may transmit (or may share) content to (or with) the connected external apparatus 1000.

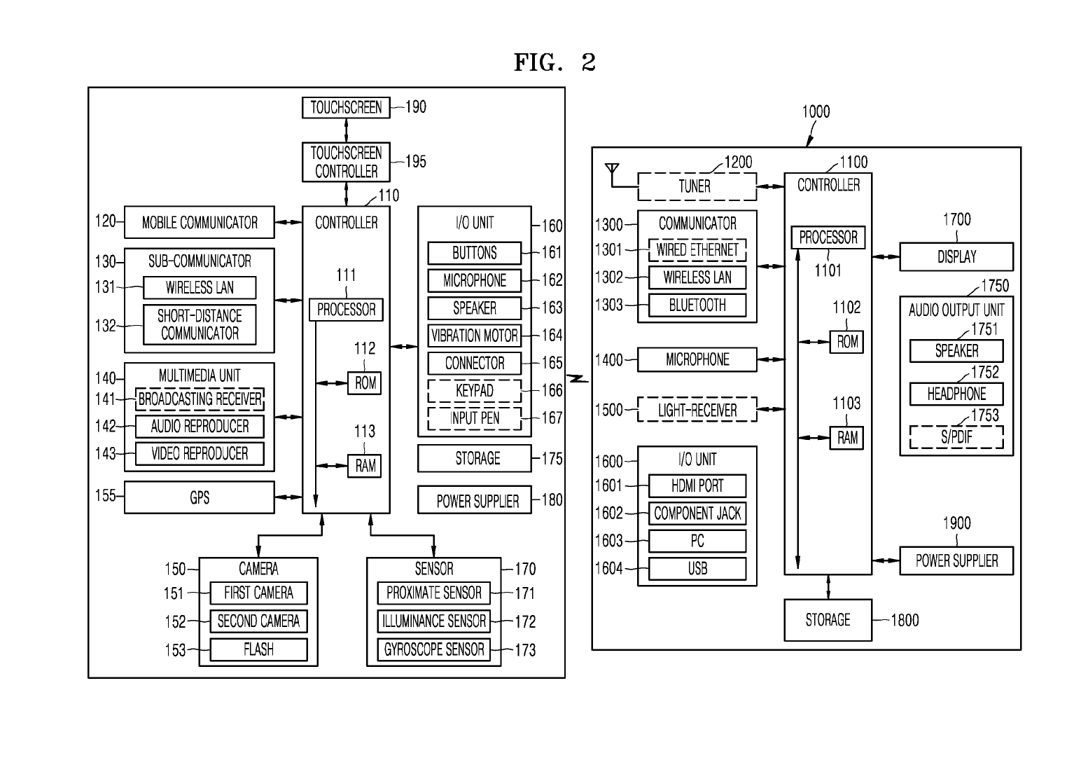

FIG. 2 is a block diagram of the portable apparatus 100 and the external apparatus 1000, according to another exemplary embodiment.

Referring to FIG. 2, the portable apparatus 100 may be connected in a wireless or wired manner to an external apparatus 1000 by using a mobile communicator 120, a sub-communicator 130, and a connector 165. The portable apparatus 100 may include a mobile phone, a smartphone, an MPEG Audio Layer-3 (MP3) player, a video player, a tablet personal computer (PC), a wearable device, a display device, an electronic interactive whiteboard, or a server. These are merely examples and the portable apparatus 100 is not limited to these examples. The display device may include an analog television (TV), a digital TV, a three-dimensional (3D) TV, a smart TV, a light-emitting diode (LED) TV, an organic light-emitting diode (OLED) TV, a plasma TV, a monitor, a curved TV with a screen having a fixed curvature, a flexible TV with a screen having a fixed curvature, a bent TV with a screen having a fixed curvature, and/or a changeable-curvature TV capable of changing its current screen curvature in response to a received user input. However, these are merely examples of the display device and the exemplary embodiments are not limited thereto.

The external apparatus 1000 may include another portable apparatus (not shown), a mobile phone (not shown), a smartphone (not shown), a tablet PC (not shown), a notebook (not shown), a portable audio device including a wireless headset, a display device, an electronic interactive whiteboard (not shown), or a server (not shown). The portable apparatus 100 is an electronic apparatus which has a touchscreen and is capable of transmitting or receiving data (or content) to or from an external source by using a mobile communicator 120 or a sub-communicator 130. Also, the portable apparatus 100 may include an electronic apparatus capable of transmitting or receiving data (or content) to or from the external apparatus 1000 by using an interaction (e.g., a touch or a touch gesture) that is input to a touchscreen 190. The portable apparatus 100 may have one or more touchscreens. Also, the portable apparatus 100 may have a plurality of screens that are divided on one touchscreen. The portable apparatus 100 includes a controller 110, a mobile communicator 120, a sub-communicator 130, a multimedia unit 140, a camera 150, a global positioning system (GPS) 155, an input/output (I/O) unit 160, a sensor 170, a storage 175, and a power supplier 180. Also, the portable apparatus 100 includes the touchscreen 190 and a touchscreen controller 195.

The controller 110 may include a processor 111, a read-only memory (ROM) 112 storing a control program for controlling the portable apparatus 100, and a random-access memory (RAM) 113 used to store a signal or data received from an external source of the portable apparatus 100 or used as a storage domain for various tasks that are performed in the portable apparatus 100.

The controller 110 controls all of the operations of the portable apparatus 100 and a flow of signals between internal elements 120 through 195 of the portable apparatus 100, and performs a data processing function. The controller 110 controls a power supply to the internal elements 120 through 195 by using the power supplier 180. Also, if a condition that is input or is set by a user and is stored is satisfied, the controller 110 may execute an OS and an application stored in the storage 175.

The processor 111 may include a graphic processing unit (GPU) (not shown) for processing graphics. The processor 111 may be embodied as a System on Chip (SoC) including a core (not shown) and the GPU. The processor 111 may include a single core, a dual-core, a triple-core, a quad-core, or a multi-core. Also, the processor 111, the ROM 112, and the RAM 13 may be connected to each other via an internal bus.

The controller 110 may control the mobile communicator 120, the sub-communicator 130, the multimedia unit 140, the camera 150, the GPS 155, the I/O unit 160, the sensor 170, the storage 175, the power supplier 180, the touchscreen 190, and the touchscreen controller 195.

The controller 110 may display a lock screen on the portable apparatus 100, may receive an input of a connection unlock pattern via the lock screen, may connect the portable apparatus 100 to the external apparatus 1000 that corresponds to the connection unlock pattern, and may distinguish the connection unlock pattern from an unlock pattern for unlocking the lock screen.

The controller 110 may control the mobile communicator 120 or the sub-communicator 130 to transmit content to the connected external apparatus 1000.

The controller 110 may control the portable apparatus 100 to be connected to the external apparatus 1000 by using a wireless communication that corresponds to the connection unlock pattern.

The controller 110 may control the connection unlock pattern to include a password, a personal identification number, or a finger print that can be input in order to connect with the external apparatus 1000.

In another exemplary embodiment, the controller 110 may display a lock screen on the portable apparatus 100, may receive an input of one of a connection unlock pattern and an unlock pattern, and if the connection unlock pattern is received, may connect the portable apparatus 100 to the external apparatus 1000 which corresponds to the connection unlock pattern, or if the unlock pattern is received, may unlock the lock screen on the portable apparatus 100.

The controller 110 may provide at least one of a visual feedback, an acoustic feedback, and a tactile feedback.

In one or more exemplary embodiments, the term “controller” includes the processor 111, the ROM 112, and the RAM 113.

The mobile communicator 120 may connect, by control of the controller 110, the portable apparatus 100 to the external apparatus 1000 by using one or more antennas via a mobile communication network. The mobile communicator 120 may exchange a wireless signal for a voice call, a video call, a short message service (SMS), a multimedia message (MMS), and data communication with a mobile phone (not shown), a smartphone (not shown), a tablet PC, or another portable apparatus (not shown) that has a connectable telephone number.

The sub-communicator 130 may include at least one selected from a wireless LAN 131 and a short-distance communicator 132. For example, the sub-communicator 130 may include one of the wireless LAN 131 and the short-distance communicator 132 or may include both the wireless LAN 131 and the short-distance communicator 132.

The wireless LAN 131 may be connected to an AP, according to a control of the controller 110, by using wireless communication in a place where the AP is installed. The wireless LAN 131 supports a wireless LAN standard (IEEE802.11x) of the Institute of Electrical and Electronics Engineers (IEEE). The short-distance communicator 132 may wirelessly connect, by a control of the controller 110, the portable apparatus 100 to the external apparatus 1000 by using short-distance communication without the AP. The short-distance communication may include Bluetooth, Bluetooth low energy, IrDA, Wi-Fi, UWB, NFC, or the like.

The portable apparatus 100 may include at least one selected from the mobile communicator 120, the wireless LAN 131, and the short-distance communicator 132, according to an operation of the portable apparatus 100. For example, the portable apparatus 100 may include one of the mobile communicator 120, the wireless LAN 131, and the short-distance communicator 132, or a combination of the mobile communicator 120, the wireless LAN 131, and the short-distance communicator 132.

In one or more exemplary embodiments, the term “communicator” includes the mobile communicator 120 and the sub-communicator 130.

The multimedia unit 140 may include a broadcasting receiver 141, an audio reproducer 142, or a video reproducer 143. The broadcasting receiver 141 may receive, by control of the controller 110, a broadcasting signal (e.g., a TV broadcasting signal, a radio broadcasting signal, or a data broadcasting signal) and broadcasting additional information (e.g., an electric program guide (EPG) or an electric service guide (ESG)) that are broadcast from an external broadcasting station via an antenna (not shown). Also, the controller 110 may reproduce the broadcasting signal and the broadcasting additional information by using the touchscreen 190, a video codec (not shown), and an audio codec (not shown).

The audio reproducer 142 may reproduce, by a control of the controller 110, an audio source (e.g., an audio file with a file format of mp3, wma, ogg, or way), which is pre-stored in the storage 175 of the portable apparatus 100 or is received from an external source, by using an audio codec.

In an exemplary embodiment, the audio reproducer 142 may reproduce, by control of the controller 110, an acoustic feedback (e.g., an output of the audio source stored in the storage 175) by using an audio codec so as to correspond to a connection with the external apparatus 1000 and a transmission of content.

The video reproducer 143 may reproduce, by control of the controller 110, a digital video source (e.g., a file with a file format of mpeg, mpg, mp4, avi, mov, or mkv), which is pre-stored in the storage 175 of the portable apparatus 100 or is received from an external source, by using a video codec. A multimedia application which can be installed in the portable apparatus 100 may reproduce an audio source or a video file by using an audio codec and/or a video codec.

In an exemplary embodiment, the video reproducer 143 may reproduce, by control of the controller 110, a visual feedback (e.g., an output of the video source stored in the storage 175) by using a video codec so as to correspond to a connection with the external apparatus 1000 and a transmission of content.

Various types of video codecs and audio codecs are generated and sold and the exemplary embodiments are not limited to a specific video codec and audio codec.

The multimedia unit 140 may include the audio reproducer 142 and the video reproducer 143 and may exclude the broadcasting receiver 141 in order to correspond to an operation or a structure of the portable apparatus 100. Also, the audio reproducer 142 or the video reproducer 143 of the multimedia unit 140 may be included in the controller 110.

In one or more exemplary embodiments, the term “audio codec” may include one or more audio codecs. In one or more exemplary embodiments, the term “video codec” may include one or more video codecs.

The camera 150 may include a first camera 151 on a front surface 100a (refer to FIG. 1) and a second camera 152 on a rear surface that captures a still image or a moving picture, according to a control of the controller 110. Also, the camera 150 may include the first camera 151 or the second camera 152. The first camera 151 or the second camera 152 may include an auxiliary light source (e.g., a flash 153) that provides an amount of light for the capturing operation.

The controller 110 may capture a 3D still image or a 3D moving picture by using the first camera 151 of the front surface 100a and an additional camera (e.g., a third camera (not shown)) that is positioned adjacent to the first camera 151 (e.g., a distance between the first camera 151 and the additional camera may be greater than about 30 mm and less than about 80 mm). Also, the first and second cameras 151 and 152 may capture a wide angle image, a telephoto image, and a macro image by using an additional lens (not shown) that is detachable to an additional adaptor (not shown).

The GPS 155 periodically receives a plurality of pieces of information (e.g., information about an accurate location and time of a GPS satellite that is receivable by the portable apparatus 100) from a plurality of GPS satellites in orbit of an earth. The portable apparatus 100 may recognize its location, a movement speed, or a time of the portable apparatus 100 by using the plurality of pieces of information received from the plurality of GPS satellites.

The I/O unit 160 may include at least one selected from one or more buttons 161, a microphone 162, a speaker 163, a vibration motor 164, the connector 165, a keypad 166, and an input pen 167.

Referring to FIGS. 1 and 2, the one or more buttons 161 include a home button 161a, a menu button 161b, and a back button 161c that are positioned at a lower portion of the front surface 100a. The one or more buttons 161 may also include a power/lock button 161d and one or more volume buttons 161e that are positioned at a side surface (not shown). Also, the one or more buttons 161 of the portable apparatus 100 may include only the home button 161a. The one or more buttons 161 of the portable apparatus 100 may be embodied as a physical button. The one or more buttons 161 of the portable apparatus 100 may be also embodied as a touch button at a bezel of an external side of the touchscreen 190. Also, the one or more buttons 161 of the portable apparatus 100 may be displayed as a text, an image, or an icon on the touchscreen 190.

The microphone 162 may receive a voice input or a sound input from an external source and may generate an electrical signal, according to a control of the controller 110. The electrical signal generated by the microphone 162 may be converted via an audio codec and may be stored in the storage 175 or may be output via the speaker 163. The microphone 162 may be positioned at one or more places on the front surface 100a, the side surface, and the rear surface. Alternatively, the microphone 162 may be positioned at one or more places only on the side surface.

The speaker 163 may externally output, by a control of the controller 110, sounds that correspond to various signals (e.g., a wireless signal, a broadcasting signal, an audio source, a video file, or image capturing) of the mobile communicator 120, the sub-communicator 130, the multimedia unit 140, or the camera 150 by using an audio codec.

The speaker 163 may output a sound (e.g., a touch manipulation sound that corresponds a telephone number being input or an image-capturing button manipulation sound) that corresponds to a function performed by the portable apparatus 100. One or more speakers 163 may be positioned at the front surface 100a, the side surface, and/or the rear surface of the portable apparatus 100. Referring to FIG. 1 and FIG. 2, a plurality of speakers (the speaker 163 and an additional speaker (not shown)) may be positioned at the front surface 100a of the portable apparatus 100. Also, a speaker may be positioned at each of the front surface 100a and the rear surface of the portable apparatus 100. Also, the speaker 163 may be positioned at the front surface 100a and a plurality of speakers (not shown) may be positioned at the rear surface of the portable apparatus 100. Also, a plurality of speakers may be positioned at the side surface. The portable apparatus 100 having an additional speaker (not shown) positioned at its side surface may provide, to a user, a sound effect different from that of a portable apparatus (not shown) having speakers positioned at its front surface and rear surface.

In an exemplary embodiment, the speaker 163 may output, by control of the controller 110, an acoustic feedback which corresponds to a connection with the external apparatus 1000 and a transmission of content.

The vibration motor 164 may convert, by a control of the controller 110, an electrical signal into a mechanical vibration. The vibration motor 164 may include a linear vibration motor, a bar-type vibration motor, a coin-type vibration motor, or a piezoelectric element vibration motor. For example, when a voice call request is received from another portable apparatus (not shown), the vibration motor 164 of the portable apparatus 100 in a vibration mode may operate according to a control of the controller 110. The portable apparatus 100 may include one or more vibration motors 164. Also, the vibration motor 164 may vibrate the portable apparatus 100 or may vibrate only a portion of the portable apparatus 100.

In the present exemplary embodiment, the vibration motor 164 may output, by control of the controller 110, a tactile feedback which corresponds to a connection with the external apparatus 1000 and a transmission of content. Also, the vibration motor 164 may provide various tactile feedbacks (e.g., strength of a vibration and a vibration duration time period) that are pre-stored or are received from the external apparatus 1000, based on a control command from the controller 110.

The connector 165 may be used as an interface for connecting the portable apparatus 100 to an external apparatus (not shown) or a power source (not shown). According to a control of the controller 110, the portable apparatus 100 may transmit data stored in the storage 175 to the external apparatus (not shown) via a wire cable connected to the connector 165 or may receive data from the external apparatus (not shown). The portable apparatus 100 may receive power from the power source (not shown) or may charge a battery (not shown) via a wire cable connected to the connector 165. Also, the portable apparatus 100 may be connected to an external accessory (e.g., a keyboard dock (not shown) via the connector 165.

The keypad 166 may receive, from a user, an input for controlling the portable apparatus 100. The keypad 166 may include a physical keypad (not shown) that is arranged at the front surface 100a of the portable apparatus 100, a virtual keypad (not shown) that is displayed on the touchscreen 190, and a physical keypad (not shown) that is connectable in a wireless or wired manner. The physical keypad (not shown) that is arranged at the front surface 100a of the portable apparatus 100 may be omitted, according to an operation or a structure of the portable apparatus 100.

The input pen 167 may touch or select an object (e.g., a menu, a text, an image, a video, a diagram, an icon, and a shortcut icon) displayed on the touchscreen 190 of the portable apparatus 100 or screens (e.g., a memo screen, a notepad screen, a calendar screen, etc.) of writing/drawing applications. The input pen 167 may touch or select content (e.g., a text file, an image file, an audio file, a video file, or a webpage) displayed on the touchscreen 190 of the portable apparatus 100 or the screens of the writing/drawing applications. Also, the input pen 167 may be used to perform handwriting on the screen (e.g., the memo screen) of a writing application or may be used to perform drawing, painting, or sketching on the screen (e.g., a canvas screen) of a drawing application displayed on the touchscreen 190 of the portable apparatus 100.

The input pen 167 may input a text or the like by touching the touchscreen 190 or by touching a virtual keypad displayed on the touchscreen 190 that is a capacitive-type touchscreen, a resistive-type touchscreen, or an electromagnetic resonance (EMR)-type touchscreen. The input pen 167 may include a stylus pen or a haptic pen (not shown) having an embedded vibration device (e.g., an actuator or a vibration motor) that vibrates. Also, the input pen 167 may operate (e.g., vibration) the vibration device, according to not only control information that is received by the portable apparatus 100 but also sensing information that is detected by a sensor (e.g., an acceleration sensor (not shown)) embedded in the input pen 167.

When the input pen 167 is withdrawn from an insertion hole (not shown), the controller 110 may execute a preset writing/drawing application and may display a screen (not shown) of the writing/drawing application on the touchscreen 190.

Also, instead of using an input pen 167, an input can be made by a finger (e.g., a thumb) of the user. For example, drawing may be input, by the finger of the user, to an application that is displayed on a capacitive-type touchscreen or a resistive-type touchscreen.

In a case where writing or drawing is input, by the finger/and or thumb of the user, to the application that is displayed on the capacitive-type touchscreen or the resistive-type touchscreen, the controller 110 may detect a touch of one of the fingers and/or the thumb by using the touchscreen 190 and the touchscreen controller 195.

Shapes or structures of the insertion hole and the input pen 167 of the portable apparatus 100 may be changed, according to an operation or a structure of the portable apparatus 100.

The sensor 170 may include one or more sensors that detect a status of the portable apparatus 100. For example, the sensor 170 may include a proximate sensor 171 that detects whether the user approaches the portable apparatus 100, an illuminance sensor 172 that detects an amount of light around the portable apparatus 100, and a gyroscope sensor 173 that detects a direction of the portable apparatus 100 by using rotational inertia. Also, the sensor 170 may include an acceleration sensor (not shown) that detects acceleration of three axes (e.g., an X-axis, a Y-axis, and a Z-axis) that are applied to the portable apparatus 100, a gravity sensor (not shown) that detects a gravity action direction or an altimeter that detects an altitude by measuring an atmospheric pressure.

The sensor 170 may measure a motional acceleration and a gravitational acceleration of the portable apparatus 100 by using the one or more sensors. Also, the sensor 170 may further include a fingerprint sensor (not shown) that detects a fingerprint of a user, or a cardiac sensor (not shown) that detects a heartbeat of the user.

The one or more sensors included in the sensor 170 detect a status of the portable apparatus 100, generate an electrical signal corresponding to a detection result, and transmit the electrical signal to the controller 110. The one or more sensors included in the sensor 170 may be added or omitted according to an operation of the portable apparatus 100.

The storage 175 may store, by control of the controller 110, signals or data that is input and output which corresponds with operations of the mobile communicator 120, the sub-communicator 130, the multimedia unit 140, the camera 150, the GPS 155, the I/O unit 160, the sensor 170, the touchscreen 190, and the touchscreen controller 195. The storage 175 may store a control program for a control operation of the portable apparatus 100 or the controller 110, GUIs related to applications that are received from a manufacturer or an external source, images for providing the GUIs, user information, documents, databases, or related data.

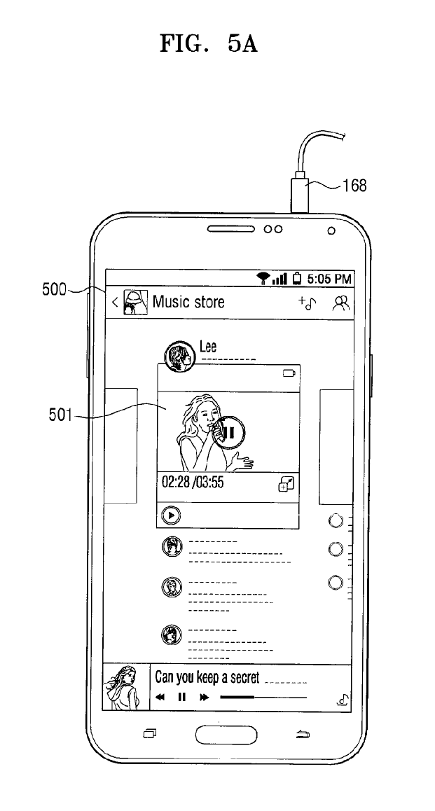

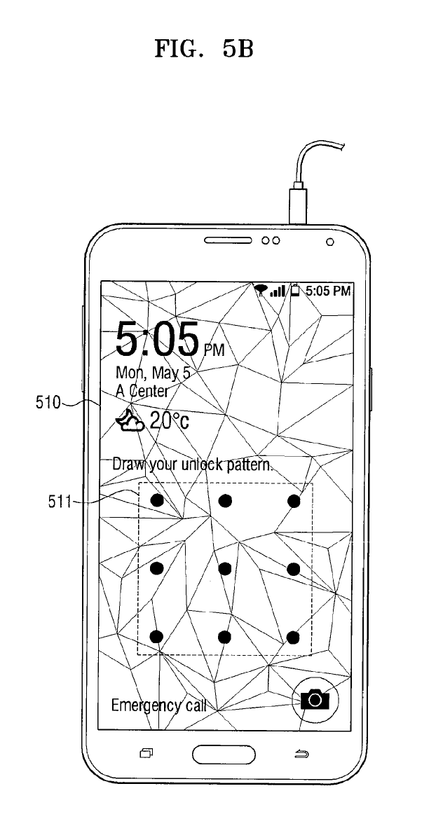

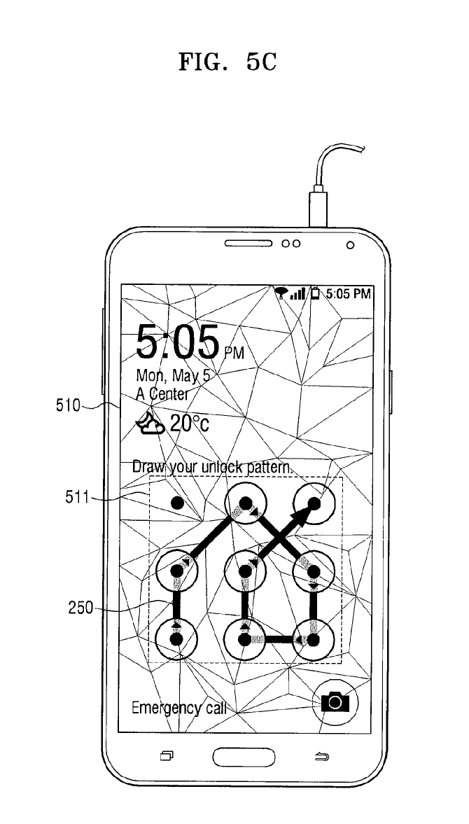

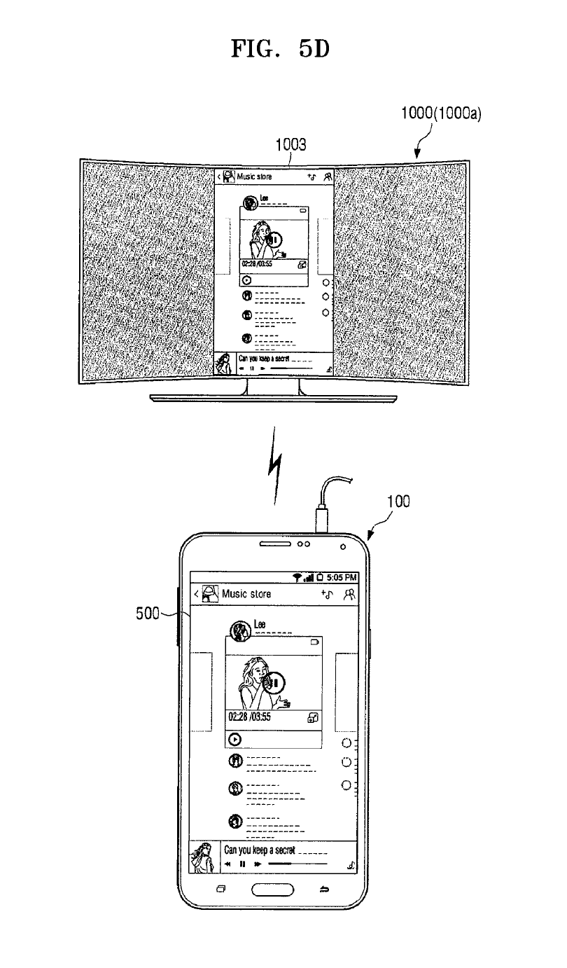

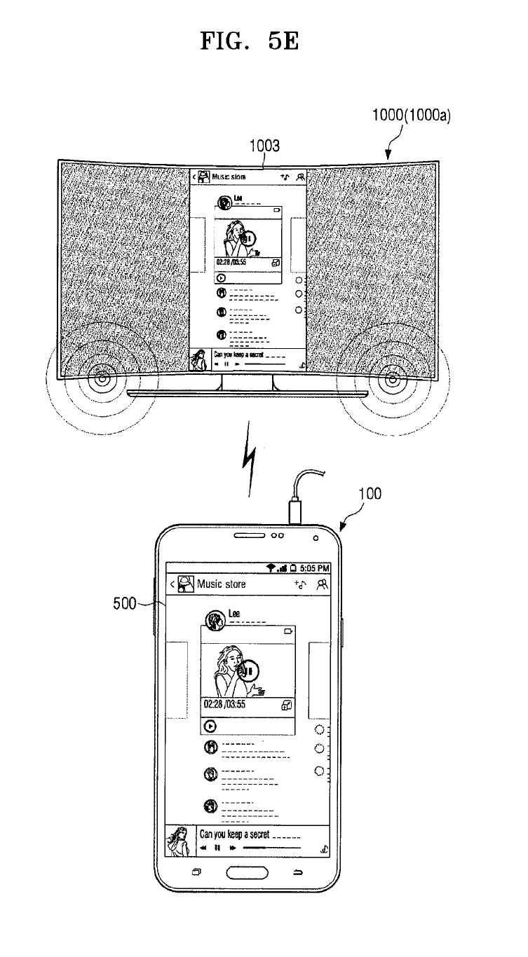

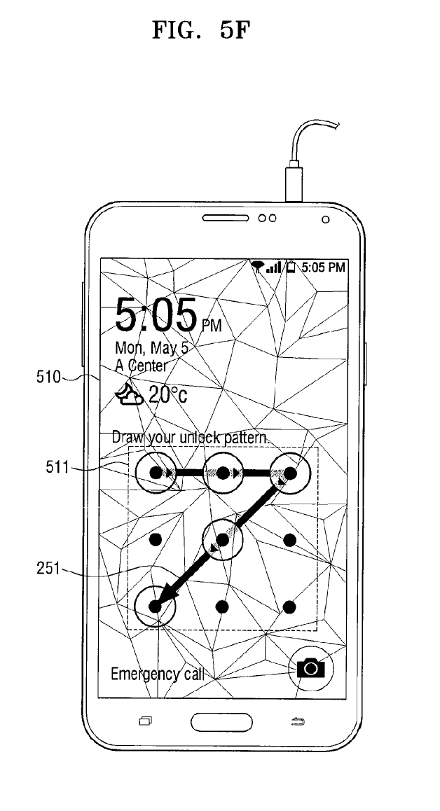

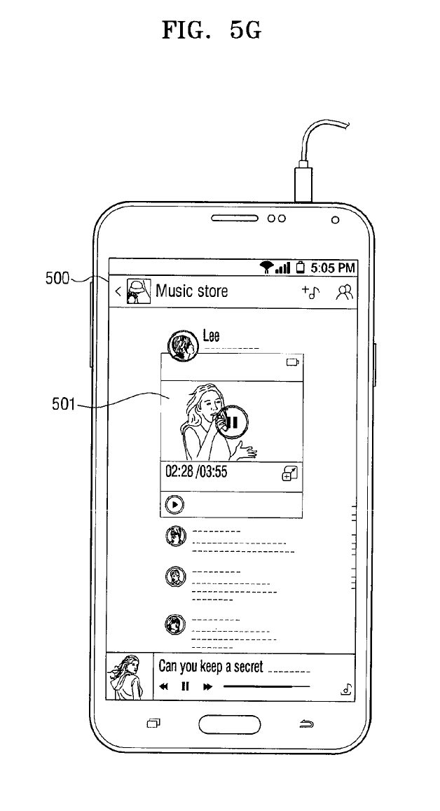

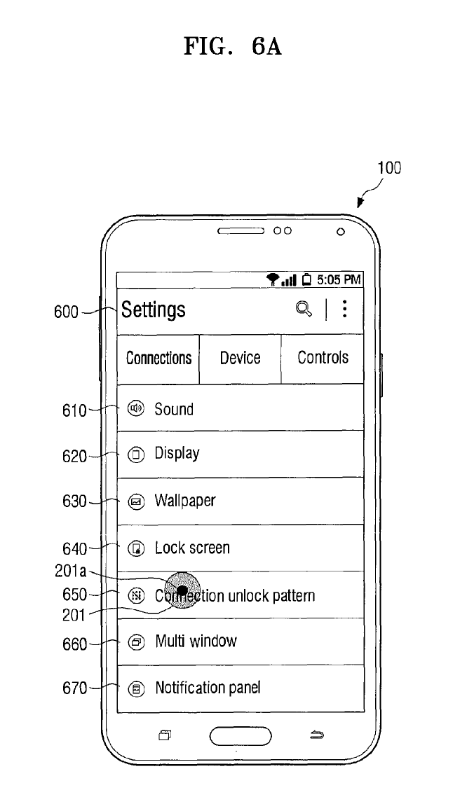

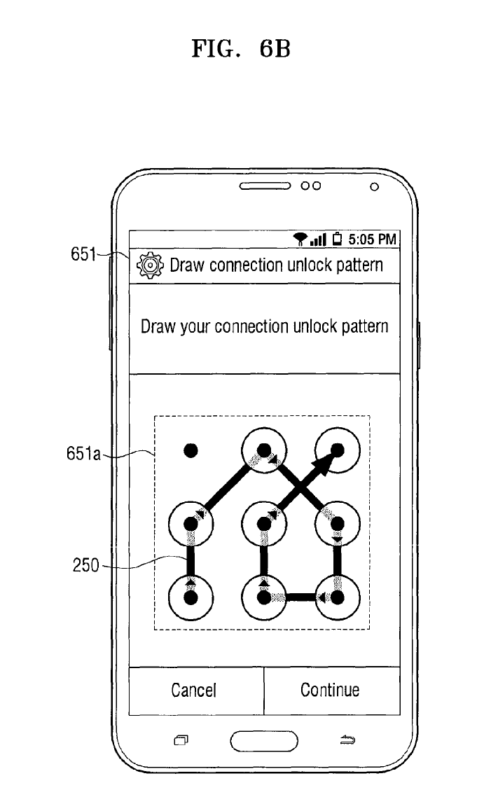

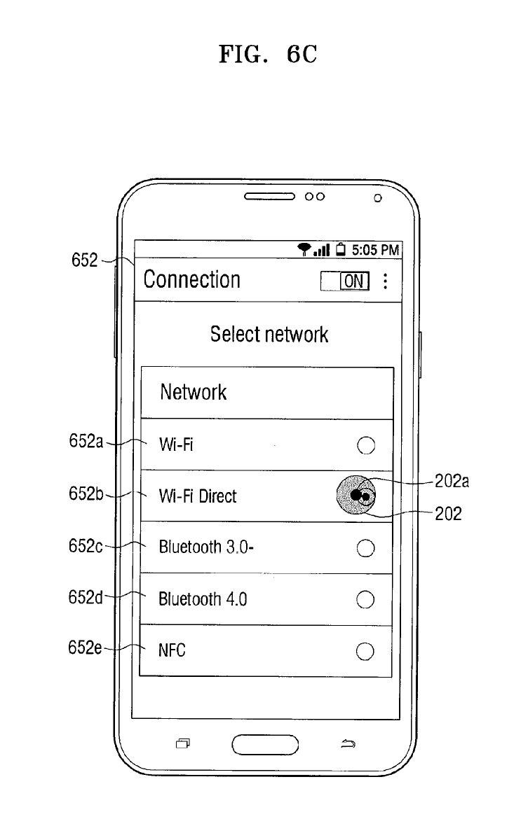

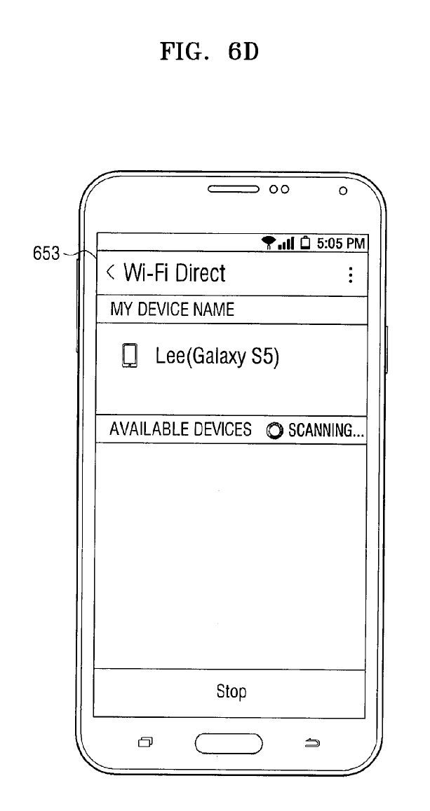

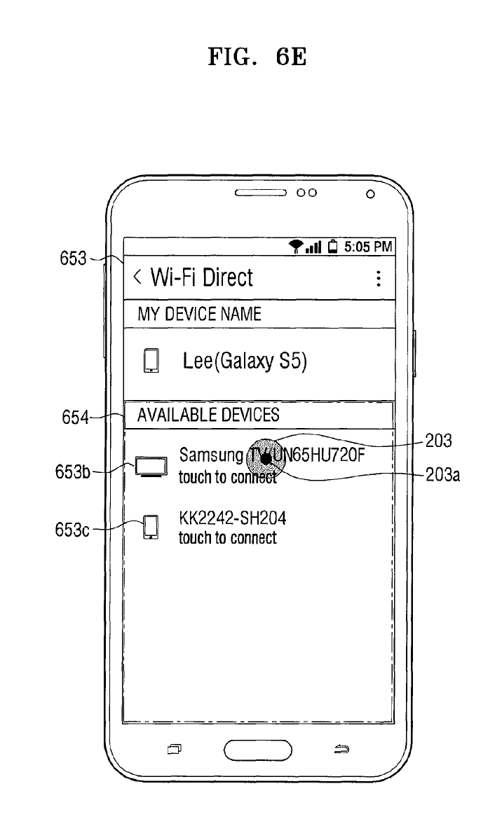

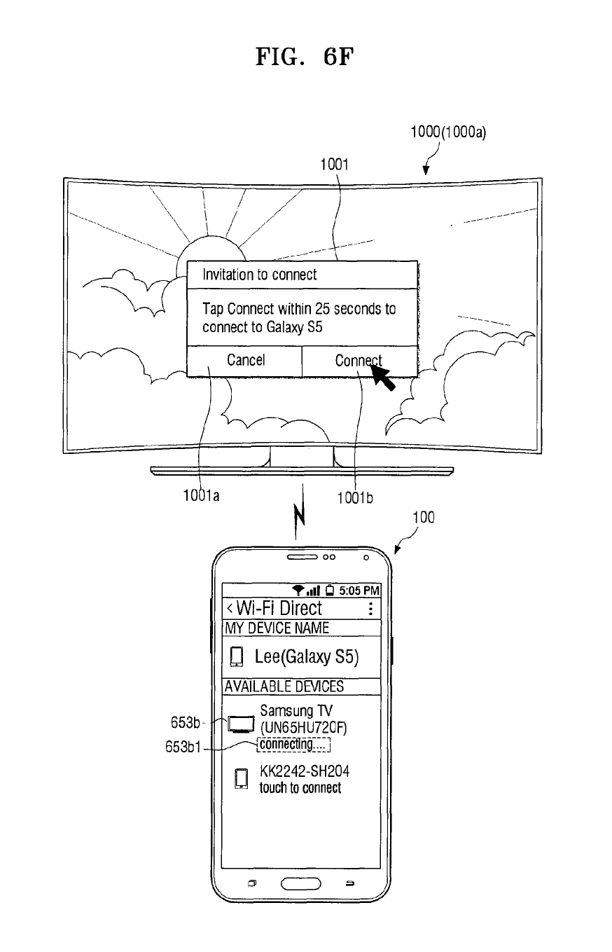

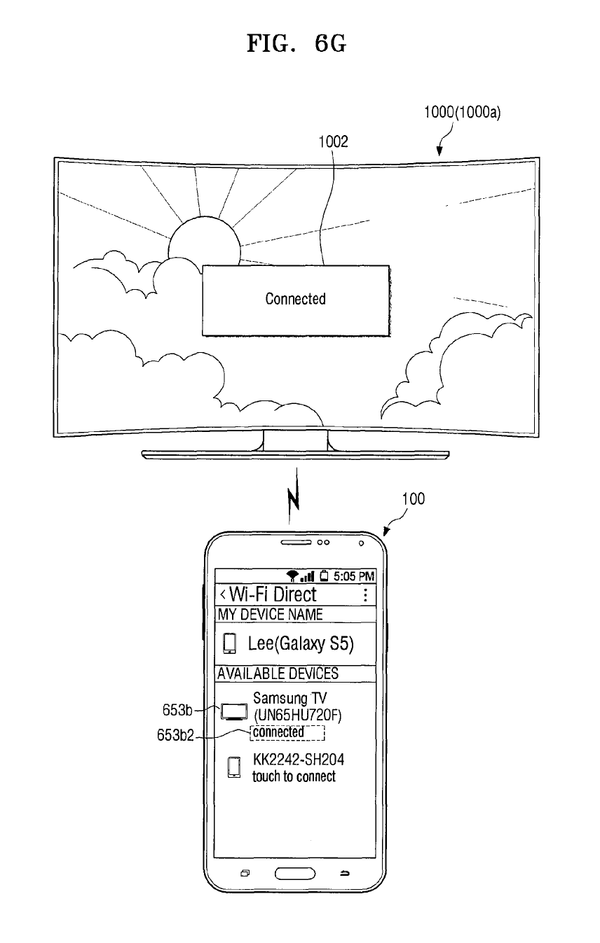

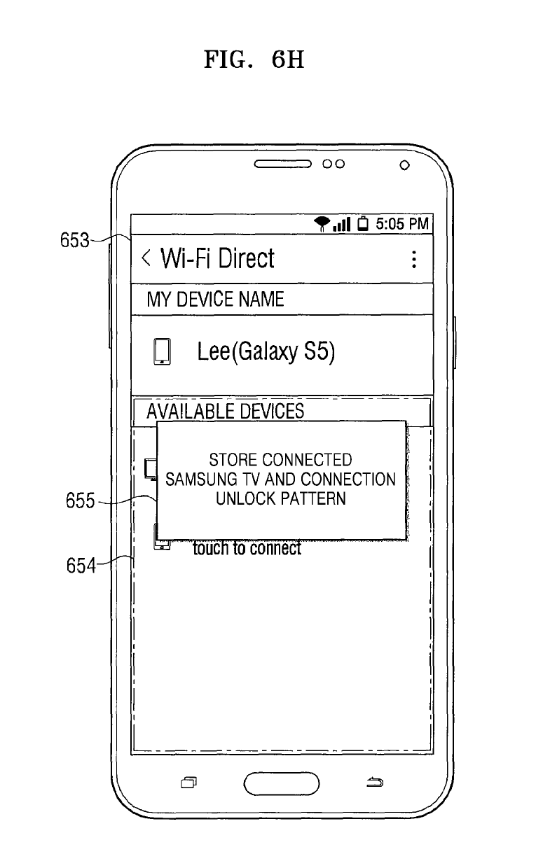

In an exemplary embodiment, the storage 175 may store a connection unlock pattern received via an input screen for a connection unlock pattern 650 (refer to FIG. 6A) and/or a connection unlock pattern received via a lock screen 510 (refer to FIG. 5C).

The storage 175 may store a wireless communication type that corresponds to the connection unlock pattern.

The storage 175 may store external apparatus connection information which is needed in order to connect with the external apparatus 1000. The external apparatus connection information may include external apparatus information (e.g., a name, an identifier (ID), a type, a class, or the like of the external apparatus 1000), a connection wireless communication type, a connection start time, etc.

The external apparatus connection information stored in the storage 175 may include registered connection unlock pattern information.

The storage 175 may store the external apparatus connection information including the registered connection unlock pattern information.

The storage 175 may separately store the external apparatus connection information and the registered connection unlock pattern information.

The storage 175 may store external apparatus connection history information (e.g., the external apparatus connection information includes the number of times of connection) that corresponds to the connection to the external apparatus 1000.

The storage 175 may store a first touch through a third touch information, a first touch location through a third touch location, and first touch location information through third touch location information. Also, the storage 175 may store first hovering through third hovering, a first hovering location through a third hovering location, and first hovering location information through third hovering location information.

The storage 175 may store a user-recognizable visual feedback (e.g., a video source, etc.) output from the touchscreen 190, a user-recognizable acoustic feedback (e.g., a sound source, etc.) output from the speaker 163, and/or a user-recognizable tactile feedback (e.g., a haptic pattern, etc.) output from the vibration motor 164 that are output so as to correspond to connection to the external apparatus 1000 and transmission of content.

The storage 175 may store a feedback providing time (e.g., 800 msec) of a feedback that is provided to the user.

In one or more exemplary embodiments, the term “storage” may include the storage 175, the ROM 112 and the RAM 113 in the controller 110, or a memory card (not shown) (e.g., a micro secure digital (SD) card, a memory stick, etc.) that is mounted in the portable apparatus 100. The storage may include a non-volatile memory, a volatile memory, a hard disk drive (HDD), or a solid state driver (SSD).

The power supplier 180 may supply, by control of the controller 110, power to the internal elements 120 through 195 of the portable apparatus 100, and one or more batteries (not shown). The one or more batteries may be positioned between the touchscreen 190 at the front surface 100a and the rear surface. The power supplier 180 may supply, by control of the controller 110, power to the portable apparatus 100, and the power is received from an external power source (not shown) via a wire cable (not shown) connected to the connector 165. Also, the power supplier 180 may be wirelessly charged (e.g., a magnetic resonance way, an electromagnetic wave way, or a magnetic induction way), according to a control of the controller 110.

The touchscreen 190 includes a touch panel (not shown) for receiving a touch input, and a display panel (not shown) for a screen display. The touchscreen 190 may provide, to the user, GUIs that correspond to various services (e.g., a voice call, a video call, data transmission, broadcasting reception, an image-capturing operation, video viewing, execution of an application, etc.). The touchscreen 190 transmits, to the touchscreen controller 195, an analog signal that corresponds to a single touch or multiple touches that are input via a home screen, a lock screen, or a GUI. The touchscreen 190 may receive an input of the single touch or the multiple touches via a body part (e.g. a finger or a thumb) of the user, or the input pen 167.

The display panel includes a plurality of pixels and displays an image by using the pixels. For example, the display panel may include a liquid crystal display (LCD) panel, an OLED panel, an LED panel, or the like. The display panel may display various operational statuses of the portable apparatus 100, and various images and a plurality of objects that occur according to executing of an application or a service.

In one or more exemplary embodiments, the term “touch” includes both direct and non-direct contact with a body part of the user or the input pen 167. For example, the non-direct contact may include hovering the body part of the user or the input pen 167 a distance equal to or less than 50 nm from the touchscreen 190. A distance of the non-direct contact that is detectable by the touchscreen 190 may be changed, according to an operation or a structure of the portable apparatus 100.

The touchscreen 190 may be embodied as a resistive-type touchscreen, a capacitive-type touchscreen, an infrared-type touchscreen, or an acoustic wave-type touchscreen.

Also, the touchscreen 190 may be embodied as an EMR-type touchscreen. The EMR-type touchscreen may further include a separate EMR-type touch panel (not shown) so as to receive an input via an input pen (not shown) having a resonance circuit that resonates with an EMR-type loop coil.

The touchscreen controller 195 converts the analog signal, which corresponds to the single touch or the multiple touches received via the touchscreen 190, into a digital signal and transmits the digital signal to the controller 110. The controller 110 may calculate coordinates of an X and Y-axis corresponding to a touch location on the touchscreen 190, by using the digital signal received from the touchscreen controller 195.

The controller 110 may control the touchscreen 190 by using the digital signal received from the touchscreen controller 195. For example, in response to the input touch, the controller 110 may display a shortcut icon (not shown) different from another shortcut icon (not shown) that is displayed on the touchscreen 190, or may execute an application (e.g., a phone application) corresponding to a selected shortcut icon (not shown) and may display a screen of the application on the touchscreen 190.

The touchscreen controller 195 may be arranged as one touchscreen controller 195 or a plurality of the touchscreen controllers 195. The touchscreen controller 195 may be included in the controller 110 so as to correspond to an operation or a structure of the portable apparatus 100.

The touchscreen controller 195 converts an analog signal into a digital signal and transmits the digital signal to the controller 110. The analog signal corresponds to a touch received via the EMR-type touchscreen and is different from the analog signal that corresponds to the signal touch or the multiple touches which is received via the touchscreen 190. The controller 110 may calculate X and Y coordinates corresponding to a touch location on the EMR-type touchscreen, by using the digital signal received from the touchscreen controller 195. Also, in the EMR-type touchscreen, an EMR-type touchscreen controller (not shown) may be used.

The portable apparatus 100 shown in FIGS. 1 and 2 has only one touchscreen, however, one or more exemplary embodiments are not limited thereto and the portable apparatus 100 may have a plurality of touchscreens. The plurality of touchscreens may be respectively arranged in housings and may be connected to each other by using hinges, or may be arranged in a flexible housing. Each of the plurality of touchscreens may include a display panel and a plurality of touch panels.

At least one of the elements of the portable apparatus 100 shown in FIG. 2 may be removed or at least one element may be added, according to an operation or a structure of the portable apparatus 100.

Referring to FIG. 2, the external apparatus 1000 may be connected to the portable apparatus 100 in a wired or wireless manner by using a communicator 1300. For example, referring to FIG. 1, the external apparatus 1000 may include another portable apparatus (not shown), a mobile phone (not shown), a smartphone (not shown), the display apparatus 1000a, a wearable apparatus 1000b, a tablet PC 1000c, a note PC (not shown), an audio output apparatus including a wireless headset 1000d or a sound bar 1000e, an interactive white board (not shown), or a server (not shown). With reference to the external apparatus 1000 of FIG. 2, the display apparatus 1000a of FIG. 1 is described as an example from among the various external apparatuses.

The display apparatus 1000a that is an example of the external apparatus 1000 may include a display 1700, a tuner 1200, a communicator 1300, and an I/O unit 1600. The display apparatus 1000a may include not only the display 1700 but also may include a combination of the tuner 1200, the communicator 1300, and the I/O unit 1600. The display apparatus 1000a having the display 1700 may be electrically connected to a separate external apparatus (e.g., a set-top box (not shown)) having a tuner. For example, the display apparatus 1000a may be embodied as an analog TV, a digital TV, a 3D TV, a smart TV, an LED TV, an OLED TV, a plasma TV, or a monitor, but an example of the display apparatus 1000a is not limited thereto.

The display apparatus 1000a includes the tuner 1200, the communicator 1300, a microphone 1400, a light receiver 1500, the I/O unit 1600, the display 1700, an audio output unit 1750, a storage 1800, and a power supplier 1900. The display apparatus 1000a may include at least one sensor (e.g., an illuminance sensor, a temperature sensor, etc. (not shown)) that detects an internal status or an external status of the display apparatus 1000a.

A controller 1100 included in the display apparatus 1000a may include a processor 1101, a ROM 1102 that stores a control program for controlling the display apparatus 1000a, and a RAM 1103 that is used to store a signal or data received from an external source of the display apparatus 1000a or is used as a storage domain for various tasks that are performed the display apparatus 1000a.

The controller 1100 controls all operations of the display apparatus 1000a and a flow of signals between internal elements 1200 through 1900 of the display apparatus 1000a, and performs a data processing function. The controller 1100 controls a power that is supplied from the power supplier 1900 to the internal elements 1200 through 1800. Also, if a condition that is input or is set by a user and is stored is satisfied, the controller 1100 may execute an OS and an application stored in the storage 1800.

The controller 1100 may be connected to the mobile communicator 120 of the portable apparatus 100 by using the communicator 1300. The controller 1100 may receive content from the mobile communicator 120 of the portable apparatus 100 by using the communicator 1300. The controller 1100 may output the received content via the display 1700 and/or an audio output unit 1750. Also, the controller 1100 may store the received content in the storage 1800.

A configuration and operations of the controller 1100 may vary in one or more exemplary embodiments.

The tuner 1200 may tune and select a frequency of a channel that a user wants to receive via the display apparatus 1000a. The frequency is obtained by tuning, via amplification, mixing, and resonance, frequency components of a broadcasting signal that is received in a wired or wireless manner. The broadcasting signal includes an audio signal, a video signal, and additional information (e.g., an EPG).

The display apparatus 1000a may include one or more tuners 1200.

The communicator 1300 may connect, by control of the controller 1100, the display apparatus 1000a to another external apparatus (e.g., an audio device, etc.). The controller 1100 may transmit content to and receive content from the other external apparatus connected by using the communicator 1300, may download an application from the other external apparatus, or may perform web browsing. The communicator 1300 may include one of a wired Ethernet 1301, a wireless LAN 1302, and Bluetooth 1303 so as to correspond to an operation and a structure of the display apparatus 1000a. Also, the communicator 1300 may include a combination of the wired Ethernet 1301, the wireless LAN 1302, and the Bluetooth 1303. The communicator 1300 may receive, by control of the controller 1100, a remote adjustment signal (including a control signal) of a remote controller (not shown). The remote adjustment signal may be implemented as a Bluetooth-type remote adjustment signal or a radio frequency (RF)-type remote adjustment signal.

The communicator 1300 may further include other short-range communication (e.g., NFC (not shown), BLE (not shown), etc.), in addition to Bluetooth.

The microphone 1400 receives an input of a user's voice. The microphone 1400 may convert the received voice into an electrical signal and may output the electrical signal to the controller 1100. The voice of the user may include a voice that corresponds to a menu or a function of the display apparatus 1000a. A perceptible range of the microphone 1400 is recommended to be within 4 cm between the microphone 1400 and a location of the user, and the perceptible range of the microphone 1400 may vary according to a volume of the voice of the user and a surrounding environment (e.g., speaker sound, ambient noise, etc.).

The microphone 1400 may be removed according to an operation and a structure of the display apparatus 1000a.

The light receiver 1500 receives an optical signal (including a control signal) from an external remote controller (not shown) via a light-receiving window of a bezel. The light receiver 1500 may receive an optical signal corresponding to a user input (e.g., a touch, a press, a touch gesture, a voice, or a motion) from the remote controller. The control signal may be extracted from the optical signal by a control of the controller 1100.

The I/O unit 1600 receives, by control of the controller 1100, a video (e.g., a moving picture, etc.), an audio (e.g., a voice, music, etc.), and additional information (e.g., an EPG, etc.) from an external source of the display apparatus 1000a. The I/O unit 1600 may include one of a high-definition multimedia interface (HDMI) port 1601, a component jack 1602, a PC port 1603, and a universal serial bus (USB) port 1604. The I/O unit 1600 may include a combination of the HDMI port 1601, the component jack 1602, the PC port 1603, and the USB port 1604.

A configuration and the operations of the I/O unit 1600 may vary in one or more exemplary embodiments.

The display 1700 may display, by a control of the controller 1100, content (e.g., a video, etc.) that is received from the portable apparatus 100 via the communicator 1300 or the I/O unit 160. By a control of the controller 1100, the display 1700 displays, on a screen, a video included in a broadcasting signal that is received by the tuner 1200. The display 1700 may output, by a control of the controller 1100, a video stored in the storage 1800.

In the present exemplary embodiment, the display 1700 may output, by control of the controller 1100, a visual feedback that corresponds to connection to the portable apparatus 100 and transmission of content.

The audio output unit 1750 may output content (e.g., music, an audio, or a sound) that is received from the portable apparatus 100 via the communicator 1300 or the I/O unit 1600. The audio output unit 1750 outputs, by control of the controller 1100, audio included in a broadcasting signal that is received by the tuner 1200. Also, the audio output unit 1750 may output, by control of the controller 1100, audio which is stored in the storage 1800. The audio output unit 1750 may include at least one of a speaker 1751, a headphone output terminal 1752, and a Sony/Philips Digital Interface Format (S/PDIF) output terminal 1753. The audio output unit 1750 may include a combination of the speaker 1751, the headphone output terminal 1752, and the S/PDIF output terminal 1753.

In the present exemplary embodiment, the audio output unit 1750 may output, by control of the controller 1100, an acoustic feedback that corresponds to connection to the portable apparatus 100 and transmission of content.

The storage 1800 may store, by a control of the controller 1100, various data, programs, or applications for driving and controlling the display apparatus 1000a. The storage 1800 may store signals or a plurality of pieces of data that are input/output so as to correspond to operations of the tuner 1200, the communicator 1300, the microphone 1400, the light receiver 1500, the I/O unit 1600, display 1700, the audio output unit 1750, and the power supplier 1900.

The storage 1800 may store a control program for a control operation by the portable apparatus 100 or the controller 110, an application that is originally provided by a manufacturer or is downloaded from an external source, a GUI related to the application, an object (e.g., an image text, an icon, a button, etc.) for providing the GUI, user information, documents, databases, or related data.

Although not illustrated, the storage 1800 may include a broadcasting receiver, a channel controller, a volume controller, a communication control module, a voice recognition module, a motion recognition module, a light-receiving module, a display control module, an audio control module, an external input control module, a power control module, a power control module for controlling a power of another external apparatus that is connected in a wireless manner (e.g., Bluetooth), a voice database, or a motion database. The aforementioned modules and databases (not shown) of the storage 1800 may be implemented as a plurality of pieces of software for performing a broadcasting reception control function, a channel control function, a volume control function, a communication control function, a voice recognition function, a motion recognition function, a light-receiving control function, a display control function, an audio control function, an external input control function, a power control function, or a power control function so as to control a power of the other external apparatus that is connected in a wireless manner (e.g., Bluetooth). The controller 1100 may perform the aforementioned functions by using the plurality of pieces of software, respectively.

The storage 1800 may store a moving picture or an image that corresponds to a visual feedback.

The storage 1800 may store sound that corresponds to an acoustic feedback.

The power supplier 1900 supplies, by a control of the controller 1100, power, which is input from an external power source, to the internal elements 1200 through 1800. Also, the power supplier 1900 may supply, by control of the controller 1100, power to the internal elements 1200 through 1800. The power is output from one or more batteries (not shown) arranged in the display apparatus 1000a.

At least one of the elements 1200 through 1900 of the external apparatus 1000 shown in FIGS. 1 and 2 may be removed or at least one element may be added thereto, according to performances and structures of various external apparatuses 1000a through 1000e. For example, the tuner 1200 may be included only in the external apparatus 1000a. The microphone 1400 may be included in the external apparatuses 1000a through 1000c. Also, the light receiver 1500 may be included only in the external apparatus 1000a.

Positions of the elements 1200 through 1900 may be changed to correspond to an operation or a structure of the external apparatus 1000 (e.g., the external apparatuses 1000a through 1000e).

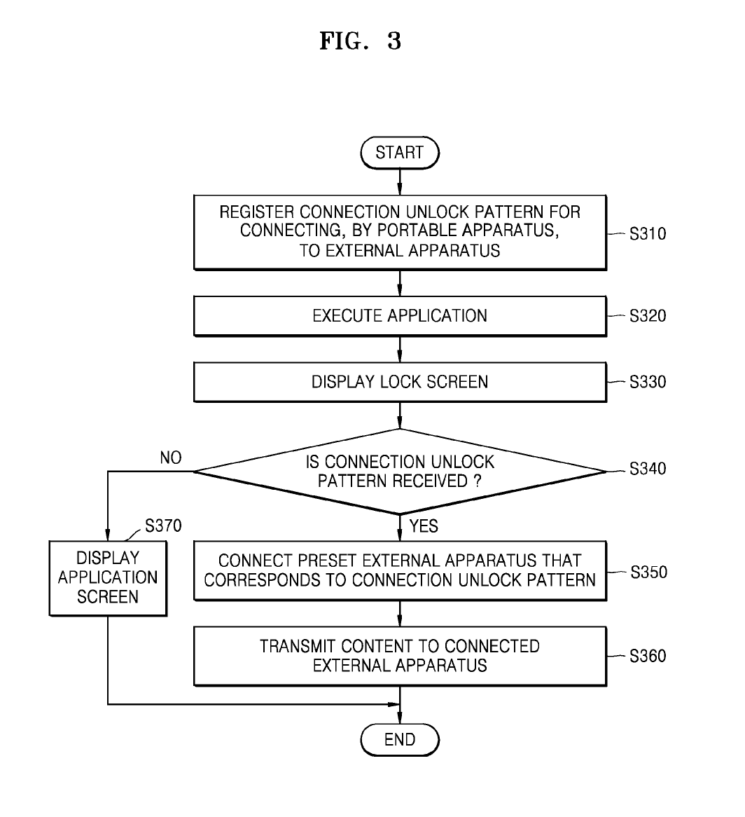

FIG. 3 is a flowchart of a method of the portable apparatus 100 connecting to the external apparatus 1000, and the method performed by the portable apparatus 100, according to an exemplary embodiment.

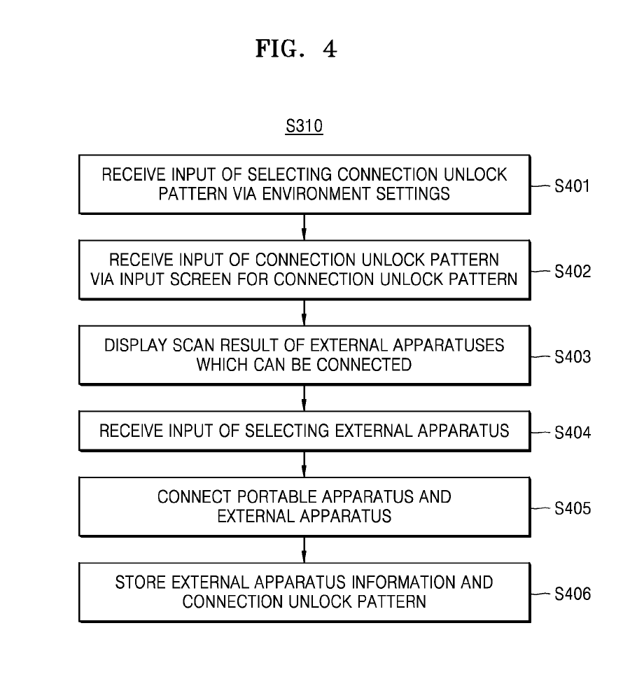

FIG. 4 is a flowchart illustrating in detail an operation S310 of FIG. 3, according to an exemplary embodiment.

FIGS. 5A through 5G illustrate examples of a screen of the portable apparatus 100, according to exemplary embodiments.

FIGS. 6A through 6H illustrate an example in which the portable apparatus 100 registers the external apparatus 1000, according to an exemplary embodiment.

In operation S310 of FIG. 3, a connection unlock pattern for connecting to the external apparatus 1000 is registered in the portable apparatus 100.

The registration of the connection unlock pattern that corresponds to operation S310 of FIG. 3 will be described in detail with reference to FIGS. 4, and 6A through 6H.

In operation S401 of FIG. 4, an input of selecting the connection unlock pattern via environment settings is received.

Referring to FIG. 6A, in an environment settings screen 600 of the portable apparatus 100, various functions of the portable apparatus 100 may be set by a user input (e.g., a touch, a voice, or a gesture). For example, items that can be set in the environment settings screen 600 may include a sound 610, a display 620, a wallpaper 630, a lock screen 640, the connection unlock pattern 650, a multi-window 660, a notification panel 670, etc. A user may input, via the item of the lock screen 640, an unlock pattern 251 (refer to FIG. 5F) as a registered unlock pattern to unlock a lock screen. The controller 110 may store, in the storage 175, registered-unlock pattern information that corresponds to the registered unlock pattern. The stored registered-unlock pattern information may include an ID of the registered unlock pattern, a shape of the registered unlock pattern, an input time of the registered unlock pattern, a start position of the registered unlock pattern, an end position of the registered unlock pattern, a touch gesture direction of the registered unlock pattern, or the like.

The user may also input, via the connection unlock pattern 650, a connection unlock pattern 250 (refer to FIG. 6B) that corresponds to connection between the portable apparatus 100 and the external apparatus 1000.

In the exemplary embodiments, the items that are set in the environment settings screen 600 may be added, changed, or deleted.

For connection to the external apparatus 1000 by using a registered connection unlock pattern, the user makes a first touch 201 to the connection unlock pattern 650 from among the items of the environment settings screen 600. The controller 110 may detect the first touch 201 by using the touchscreen 190 and the touchscreen controller 195. The controller 110 may calculate, by using an electrical signal received from the touchscreen controller 195, a first touch location 201a (e.g., coordinates of X1 and Y1) that corresponds to the first touch 201.

The controller 110 may store, in the storage 175, first touch location information that corresponds to the first touch location 201a. The stored first touch location information may include a touch ID, a touched location, a touch detection time, touch information (e.g., a touch pressure, a touch direction, a touch duration time, etc.), or the like that are used in managing a history.

Also, the controller 110 may detect a first hovering (not shown) by using the touchscreen 190 and the touchscreen controller 195. The controller 110 may calculate, by using an electrical signal received from the touchscreen controller 195, a first hovering location (not shown) (e.g., coordinates of X11 and Y11) that corresponds to the first hovering.

The controller 110 may store, in the storage 175, first hovering location information that corresponds to the first hovering location. The stored first hovering location information may include a hovering detection location, a hovering detection time, hovering information (e.g., a hovering height (h), a hovering direction, a hovering duration time, etc.), or the like.

In operation S402 of FIG. 4, an input of the connection unlock pattern is received via an input screen for the connection unlock pattern.

Referring to FIG. 6B, the controller 110 may display a connection unlock pattern input screen 651, in response to the first touch 201. A user may input the connection unlock pattern 250 by using nine (9) points 651a that are displayed on the connection unlock pattern input screen 651. The user may input the connection unlock pattern 250 by using a user input (e.g., a touch, hovering, an input pen, a voice, or a motion) that connects a plurality of points from among the nine (9) points 651a. The connection unlock pattern 250 may include a continuous movement of a touch (e.g., a touch gesture).

The controller 110 may detect the connection unlock pattern 250 by using the touchscreen 190 and the touchscreen controller 195. The controller 110 may calculate, by using an electrical signal received from the touchscreen controller 195, a connection unlock pattern shape (e.g., a plurality of coordinates of X and Y) that corresponds to the connection unlock pattern 250. Also, the controller 110 may receive an input of the connection unlock pattern 250 a plurality of times so as to register the connection unlock pattern 250.

The controller 110 may store, in the storage 175, registered connection unlock pattern information that corresponds to the connection unlock pattern 250. The registered connection unlock pattern information may include an ID of a registered connection unlock pattern, a shape of the registered connection unlock pattern, an input time of the registered connection unlock pattern, a start position of the registered connection unlock pattern, an end position of the registered connection unlock pattern, a touch gesture direction of the registered connection unlock pattern, or the like.

The controller 110 may store, in the storage 175, a plurality of pieces of registered connection unlock pattern information that correspond the number of input connection unlock patterns. For example, if the number of the input connection unlock patterns is 2, the controller 110 may store, in the storage 175, two pieces of registered connection unlock pattern information. If the number of the input connection unlock patterns is 3, the controller 110 may store, in the storage 175, three pieces of registered connection unlock pattern information.

In operation S403 of FIG. 4, a scan result of external apparatuses which can be connected is displayed.

Referring to FIG. 6C, the controller 110 displays a wireless communication selection screen 652 for receiving an input of wireless communication so as to correspond to an input of the connection unlock pattern 250. Various types of wireless communications that are connectable with the external apparatus 1000 are displayed on the wireless communication selection screen 652. For example, Wi-Fi 652a, Wi-Fi direct 652b, Bluetooth 3.0 652c, Bluetooth 4.0 652d, NFC 652e, or the like may be displayed.

The user makes a second touch 202 to the Wi-Fi direct 652b from among items displayed on the wireless communication selection screen 652. The controller 110 may detect the second touch 202 by using the touchscreen 190 and the touchscreen controller 195. The controller 110 may calculate, by using an electrical signal received from the touchscreen controller 195, a second touch location 202a (e.g., coordinates of X2 and Y2) that corresponds to the second touch 202.

Referring to FIG. 6D, the controller 110 may display a Wi-Fi direct connection screen 653, in response to the second touch 202. In response to the second touch 202, the controller 110 may scan the external apparatus 1000 that is automatically connectable, by using Wi-Fi direct communication. Also, in response to the second touch 202 and an additional touch (not shown), the controller 110 may scan the external apparatus 1000 that is manually connectable, by using the Wi-Fi direct communication. In an exemplary embodiment the external apparatus 1000 in which Wi-Fi direct communication is activated may be scanned. In the exemplary embodiment, the available devices is shown after selecting a wireless communication, however, the exemplary embodiments are not limited to this. For example, a list of available devices can appear after the connection unlock pattern, as shown in FIG. 6B, is input.

The external apparatus 1000 in which wireless communication, other than the Wi-Fi direct communication, is activated may also be scanned by using the wireless communication.

Referring to FIG. 6E, when scanning the external apparatus 1000 that can be connected by using the Wi-Fi direct communication is completed, the controller 110 may display a scanned available external apparatuses list 654 on the Wi-Fi direct connection screen 653. The available external apparatuses list 654 may include external apparatus items such as icons, IDs, model names, etc. that correspond to external apparatuses 653b and 653c, respectively.

In operation S404 of FIG. 4, an input of selecting a connection-target external apparatus is received.

Referring to FIG. 6E, the user makes a third touch 203 to the connection-target external apparatus (e.g., one of an icon, an ID, and a model name that correspond to the display apparatus 1000a) on the Wi-Fi direct connection screen 653. The controller 110 may detect the third touch 203 by using the touchscreen 190 and the touchscreen controller 195. The controller 110 may calculate, by using an electrical signal received from the touchscreen controller 195, a third touch location 203a (e.g., coordinates of X3 and Y3) that corresponds to the third touch 203. In response to the third touch 203, the controller 110 may determine the display apparatus 1000a as an external apparatus to be connected by using the Wi-Fi direct communication.

The controller 110 may store, in the storage 175, third touch location information that corresponds to the third touch location 203a.

In operation S405 of FIG. 4, the portable apparatus 100 and the external apparatus 1000 are connected.

Referring to FIGS. 6F and 6G, in response to the third touch 203, the controller 110 may request the external apparatus 1000a for a connection by using the communicator 120 or 130 of the portable apparatus 100. In response to the third touch 203, the controller 110 may request the external apparatus 1000a to connect by using the Wi-Fi direct communication.

A pop-up window 1001 that corresponds to the connection request by the portable apparatus 100 may be displayed on a screen of the external apparatus 1000a. The controller 110 may display a connecting mark 653b1 with respect to the external apparatus 1000a on the Wi-Fi direct connection screen 653 of the portable apparatus 100.

The user may select, by using a remote controller (not shown), a connect menu 1001b with respect to the connection request by the portable apparatus 100 or a cancel menu 1001a. The portable apparatus 100 could also be used to select the menu items on the external apparatus 1000.

In response to selection (e.g., the selection of the connect menu 1001b) of the user, the controller 1100 of the external apparatus 1000a may display a pop-up window 1002 that corresponds to a connection between the external apparatus 1000a and the portable apparatus 100. The controller 1100 of the external apparatus 1000a may store, in the storage 1800, portable apparatus connection information that corresponds to the connection with the portable apparatus 100. The portable apparatus connection information may include portable apparatus information (e.g., a name of the portable apparatus 100, an ID of the portable apparatus 100, a type of the portable apparatus 100, a class of the portable apparatus 100, etc.), a type of a connected wireless communication, a connection start time, a number of times of access, etc. Also, the controller 1100 of the external apparatus 1000a may store portable apparatus connection history information (e.g., the portable apparatus connection information includes a number of times of a connection) that corresponds to the connection with the portable apparatus 100.

Also, in response to the connection between the portable apparatus 100 and the external apparatus 1000a, the controller 110 of the portable apparatus 100 may display a connected mark 653b2 with respect to the external apparatus 1000a on the Wi-Fi direct connection screen 653.

In operation S406 of FIG. 4, external apparatus connection information (e.g., external apparatus information and connection unlock pattern) is stored.

Referring to FIG. 6H, the controller 110 may display a pop-up window 655 that corresponds to storing the external apparatus connection information by the storage 175. The controller 110 may display the pop-up window 655 for a preset period of time. For example, the pop-up window 655 can be displayed for 500 ms, however that is merely an example.

The controller 110 may store, in the storage 175, the external apparatus connection information that corresponds to the connection with the external apparatus 1000a. The external apparatus connection information may include external apparatus information (e.g., a name of the external apparatus 1000a, an ID of the external apparatus 1000a, a type of the external apparatus 1000a, a class of the external apparatus 1000a, etc.), a type of a connected wireless communication, a connection start time, etc. The controller 110 may allow the external apparatus connection information to include registered connection unlock pattern information. The controller 110 may store, in the storage 175, the external apparatus connection information including the registered connection unlock pattern information. Alternatively, the controller 110 may separately store, in the storage 175, the external apparatus connection information and the registered connection unlock pattern information. For example, if the connection unlock pattern 250 is received, the controller 110 may connect the portable apparatus 100 to the external apparatus 1000a by using the external apparatus connection information. If another connection unlock pattern (not shown) is received, the controller 110 may connect the portable apparatus 100 to an external apparatus 1000c by using external apparatus connection information.

The controller 110 may store external apparatus connection history information (e.g., the external apparatus connection information includes a number of times a connection has been established) that corresponds to the connection with the external apparatus 1000a.

In an exemplary embodiment, the controller 110 may connect to the external apparatus 1000 that corresponds to a set connection unlock pattern, by using the set connection unlock pattern (e.g., the set connection unlock pattern that is included in the registered connection unlock pattern information and the external apparatus connection information).

The controller 110 may unlock a lock screen by using the connection unlock pattern, a personal identification number (PIN) of, for example, at least 4 digits, a password including a combination of a letter, a number, and a symbol, or a fingerprint/thumbprint.

In another exemplary embodiment, a connection unlock pattern may include a connection PIN, a connection password, or a connection fingerprint that can be set in the environment settings of the portable apparatus 100. In this case, the controller 110 may connect to an external apparatus that corresponds to the connection unlock pattern, by using the connection unlock pattern including the connection PIN, the connection password, or the connection fingerprint/thumbprint. Also, the controller 110 may connect to an external apparatus that corresponds to a connection unlock pattern, by using a combination of connection unlock patterns including a connection PIN, a connection password, and a connection fingerprint. For example, the controller 110 may connect to an external apparatus1 (e.g., the external apparatus 1000a) by using the combination of the connection unlock patterns, may connect to an external apparatus2 (e.g., the external apparatus 1000b) by using the connection PIN, may connect to an external apparatus3 (e.g., the external apparatus 1000c) by using the connection password, or may connect to an external apparatus4 (e.g., the external apparatus 1000d) by using a fingerprint of a little finger.

When the pop-up window 655 is displayed in operation S406 of FIG. 4, registration of an external apparatus by using the connection unlock pattern ends in the portable apparatus 100.

In operation S320 of FIG. 3, an application is executed.

Referring to FIG. 5A, a shortcut icon (not shown) that corresponds to the application (e.g., a music player) is selected by a user input in the portable apparatus 100. The controller 110 may display an application screen 500 of the application that is executed which corresponds to the selected shortcut icon. A user may select a desired music object 501 on the application screen 500. The controller 110 may reproduce music that corresponds to the selection of the user (e.g., the selection of the music object 501). The user may listen to the reproduced music by using headphones 168 or earphones (not shown) that is connected to the portable apparatus 100. Also, the user may listen to the reproduced music via the speaker 163 of the portable apparatus 100. If an additional user input does not occur on the application screen 500 within a set period of time, for example, within 20 seconds, the controller 110 may close the application screen 500 so as to reduce power consumption of a battery.

In operation S330 of FIG. 3, the lock screen 510 is displayed.

Referring to FIG. 5B, the controller 110 may display the lock screen 510 so as to correspond to a selection of the button 161 by the user. The lock screen 510 includes 9 points 511. The user may input an unlock pattern so as to unlock the lock screen 510 by using a plurality of points from among the 9 points 511. Also, the user may input a connection unlock pattern to the lock screen 510 by using a plurality of points from among the 9 points 511 so as to connect the portable apparatus 100 to the external apparatus 1000.

In operation S340 of FIG. 3, it is determined whether the connection unlock pattern is received.

Referring to FIG. 5C, a connection unlock pattern 250 is received to the lock screen 510. The controller 110 may compare the received connection unlock pattern 250 with registered connection unlock pattern information that is previously stored in the storage 175. Also, controller 110 may compare the received connection unlock pattern 250 with registered unlock pattern information that is previously stored in the storage 175. The controller 110 may store, in the storage 175, authenticated connection unlock pattern information that corresponds to the received connection unlock pattern 250. The authenticated connection unlock pattern information may include an ID, a number of times of authentication, a shape, an input time, a start position, an end position, a touch gesture direction, or the like that are related to the authenticated connection unlock pattern 250.

If the portable apparatus 100 does not include registered connection unlock pattern information that corresponds to the received connection unlock pattern 250, the controller 110 may display, on the lock screen 510, a pop-up window (not shown) for requesting a re-input.

If the connection unlock pattern is received in operation S340 of FIG. 3, the method proceeds to operation S350 of FIG. 3.

In the operation S350 of FIG. 3, a set external apparatus that corresponds to the connection unlock pattern is connected.

The controller 110 may connect to the external apparatus 1000a that corresponds to the connection unlock pattern 250, by using the mobile communicator 120 or the sub-communicator 130. The controller 110 may compare the connection unlock pattern 250 with the registered unlock pattern information. The controller 110 may determine the external apparatus 1000a and wireless communication that are connection targets. The controller 110 may connect the portable apparatus 100 to the determined external apparatus 1000a, by using the mobile communicator 120.

The connection between the portable apparatus 100 and the external apparatus 1000a in operation S350 of FIG. 3 may be substantially the same as operation S405 of FIG. 4.

In operation S360 of FIG. 3, content is transmitted to the connected external apparatus 1000a.

Referring to FIGS. 5D and 5E, the controller 110 may transmit content (e.g., the application screen 500 and music streaming) to the external apparatus 1000a. Also, the controller 110 may sequentially transmit the application screen 500 and music streaming.

The controller 110 may transmit the application screen 500 to the external apparatus 1000a. The external apparatus 1000a may display a screen 1003 that is the same as the application screen 500 received from the portable apparatus 100. Also, the external apparatus 1000a may scale (e.g., magnify or reduce) the application screen 500 received from the portable apparatus 100 and may display the scaled application screen 500.

The screen 1003 may be substantially similar to the application screen 500 of the portable apparatus 100, according to an operation or a structure of the external apparatus 1000a. For example, the portable apparatus 100 may display a rectangular-shape screen, and the external apparatus 1000a may display a screen with a curvature.

A direction of the application screen 500 displayed on the external apparatus 1000a may be determined so as to correspond to a screen direction of the portable apparatus 100. For example, if the screen direction of the portable apparatus 100 is a portrait direction, the direction of the application screen 500 displayed on the external apparatus 1000a may be vertical. If the screen direction of the portable apparatus 100 is a landscape direction, the direction of the application screen 500 displayed on the external apparatus 1000a may be horizontal.

The controller 110 may stream music to the external apparatus 1000a. The external apparatus 1000a may output the music, which is streamed from the portable apparatus 100, by using a plurality of speakers (not shown) of the external apparatus 1000a.

The controller 110 may transmit various contents as well as music to the external apparatus 1000 connected to the portable apparatus 100. For example, the various contents may include a video or an audio that is reproduced in a video player, a webpage that is displayed on a web browser, a photo that is displayed in a photo gallery, or an audio, a video, a text, an image, or a webpage that is displayed or is executed in an application.

In the present exemplary embodiment, the controller 110 may seamlessly transmit content to the external apparatus 1000a that is connected to correspond to the connection unlock pattern 250 that is input to the lock screen 510. The content is reproduced (or displayed) in an application executed in the portable apparatus 100. In another exemplary embodiment, when the portable apparatus 100 is connected to the external apparatus 1000a so as to correspond to the connection unlock pattern 250 that is input to the lock screen 510, the controller 110 may execute another application (e.g., a video player) according to a user input, and may transmit a video reproduced in the application to the external apparatus 1000a. A priority order of connection to the external apparatus 1000a that corresponds to the connection unlock pattern 250, and transmission of content may be changed by a user.

The controller 110 may provide a user with feedback that corresponds to the connection to the external apparatus 1000a and the transmission of content. The feedback provided to the user may be one of a visual feedback, an acoustic feedback, and a tactile feedback. The controller 110 may provide the user with one of the visual feedback, the acoustic feedback, and the tactile feedback or a combination of the visual feedback, the acoustic feedback, and the tactile feedback.

The visual feedback may have different visual effects (e.g., a separate image or an animation effect such as a fade that was applied to the separate image), which corresponds to the connection to the external apparatus 1000a and the transmission of content, from the displayed application screen 500. The acoustic feedback as sound that corresponds to the connection to the external apparatus 1000a and the transmission of content may be output from the speaker 163. The tactile feedback may be output by using the vibration motor 164 so as to correspond to the connection to the external apparatus 1000a and the transmission of content.

The feedback may be maintained from the connection to the external apparatus 1000a to a start of the transmission of content. In environment settings (not shown) of the portable apparatus 100, the feedback (e.g., at least one selected from the visual feedback, the acoustic feedback, and the tactile feedback) that corresponds to the connection to the external apparatus 1000a and the transmission of content may be selected and/or changed.

A feedback providing time, in which at least one feedback is provided to a user during, e.g., 800 msec, may be input or may be changed by the user.

In operation S360 of FIG. 3, if content is transmitted from the connected external apparatus 1000, the method of connecting to the external apparatus 1000 performed by the portable apparatus 100 ends.

Returning to the operation S340 of FIG. 3, in the operation S340 of FIG. 3, if a unlock pattern instead of the connection unlock pattern is received, the method proceeds to operation S370 of FIG. 3.

In the operation S370 of FIG. 3, an application screen of the application is displayed.

Referring to FIGS. 5F and 5G, the unlock pattern 251 is input to the lock screen 510. The controller 110 may compare the received unlock pattern 251 with registered-unlock pattern information that was previously stored in the storage 175. The controller 110 may store, in the storage 175, authenticated unlock pattern information that corresponds to the unlock pattern 251. The authenticated unlock pattern information may include an ID of an authenticated unlock pattern, a number of times of authentication, a shape of the authenticated unlock pattern, an input time of the authenticated unlock pattern, a start position of the authenticated unlock pattern, an end position of the authenticated unlock pattern, a touch gesture direction of the authenticated unlock pattern, or the like.

When the unlock pattern 251 is received, the controller 110 displays the application screen 500 and can continuously reproduce music.

In operation S370 of FIG. 3, if the application screen is displayed, the method of connecting to the external apparatus 1000, the method performed by the portable apparatus 100, is ended.

As described above, according to the one or more of the above exemplary embodiments, by using the method of connecting to the external apparatus, the portable apparatus may connect to the external apparatus that corresponds to the connection unlock pattern that is input to the lock screen.

Also, according to the one or more of the above exemplary embodiments, by using the method of connecting to the external apparatus, the portable apparatus may connect to the external apparatus that corresponds to the connection unlock pattern that is input to the lock screen, and may transmit content to the external apparatus.

Also, according to the one or more of the above exemplary embodiments, by using the method of connecting to the external apparatus, the portable apparatus may compare a plurality of set connection unlock patterns with a connection unlock pattern received via the lock screen, based on the stored external apparatus connection information, and may connect to the external apparatus that is determined to correspond to the received connection unlock pattern.

Also, according to the one or more of the above exemplary embodiments, by using the method of connecting to the external apparatus, the portable apparatus may compare various sets of connection unlock patterns with a connection unlock pattern received via the lock screen, based on the stored external apparatus connection information, and may connect to the external apparatus that is determined to correspond to the received connection unlock pattern.

Also, according to the one or more of the above exemplary embodiments, by using the method of connecting to the external apparatus, the portable apparatus may connect to the external apparatus that corresponds to a connection unlock pattern that is input to the lock screen.

The one or more of the above exemplary embodiments of the inventive concept can also be embodied as programmed commands to be executed in various computer means, and can be recorded to a non-transitory computer-readable recording medium. The computer-readable recording medium may include one or more of the programmed commands, data files, data structures, or the like. The non-transitory computer-readable recording medium that is erasable or is re-recordable may be embodied as a volatile or non-volatile storage device such as a ROM, a memory such as a RAM, a memory chip, or an integrated circuit, or a storage medium such as a CD, a DVD, a magnetic disc or a magnetic tape that is optically or magnetically recordable and simultaneously is readable by a machine (e.g., a computer). A memory that may be included in a mobile terminal is an example of a machine-readable storing medium for storing one or more programs that include instructions to implement one or more of the above exemplary embodiments. The programmed commands recorded to the non-transitory computer-readable recording medium may be particularly designed or configured for the inventive concept.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A method of connecting a portable apparatus to an external apparatus, the method comprising:
displaying, by the portable apparatus, a lock screen;
detecting a connection unlock pattern that is input to the lock screen; and
connecting the portable apparatus to the external apparatus that corresponds to the connection unlock pattern that is input,
wherein the connection unlock pattern is different from an unlock pattern for unlocking the lock screen.

2. The method of claim 1, further comprising transmitting content to the external apparatus in response to the portable apparatus being connected to the external apparatus.

3. The method of claim 1, wherein the connecting comprises connecting the portable apparatus to the external apparatus by using a wireless communication that corresponds to the connection unlock pattern.

4. The method of claim 1, wherein the connection unlock pattern comprises one of a password, a personal identification number (PIN), and a fingerprint of at least one finger that is input for connecting to the external apparatus.

5. The method of claim 1, further comprising storing the connection unlock pattern and an external apparatus connection information that comprises external apparatus information about the external apparatus that is connected to the portable apparatus which corresponds to the connection unlock pattern.

6. The method of claim 5, wherein the storing comprises:
receiving an input of selecting a wireless communication method that corresponds to the connection unlock pattern; and
scanning the external apparatus by using the selected wireless communication method.

7. The method of claim 1, further comprising providing at least one selected from a visual feedback, an acoustic feedback, and a tactile feedback corresponding to a connection with the external apparatus.

8. A portable apparatus comprising:
a communicator;
a storage configured to store a connection unlock pattern and an external apparatus connection information comprising information about an external apparatus that is connected to the portable apparatus which corresponds to the connection unlock pattern;
a touchscreen configured to display a lock screen; and
a controller configured to control the communicator, the storage, and the touchscreen,
wherein the controller is configured to unlock the lock screen by detecting the connection unlock pattern that is input to the lock screen, and connect the portable apparatus to the external apparatus via the communicator by using the connection unlock pattern and the external apparatus connection information.

9. The portable apparatus of claim 8, wherein the controller is configured to connect the portable apparatus to the external apparatus by using a selected wireless communication method.

10. The portable apparatus of claim 8, wherein the controller is configured to transmit content of the portable apparatus to the external apparatus.

11. The portable apparatus of claim 8, wherein, in response to an unlock pattern being input to the lock screen, the controller unlocks the lock screen.

12. An external apparatus comprising:
a communicator configured to connect to a portable apparatus;
a display; and
a controller configured to control the communicator and the display,
wherein the controller is configured to control the display to display content received from the portable apparatus which is connected to the external apparatus by using the communicator.

13. The external apparatus of claim 12, further comprising an audio output unit, and
wherein the controller is configured to control the audio output unit to output audio corresponding to the content.

14. The external apparatus of claim 12, wherein the content comprises one of a video, an audio, a photo, a webpage, and a screen of an application.

15. The external apparatus of claim 12, wherein the controller is configured to scale the content based on a result of comparing the content with content that is displayed on the portable apparatus, and configured to display the scaled content on the display.

16. A method of connecting a portable apparatus to an external apparatus, in which the method is performed by the portable apparatus, the method comprising:
displaying, by the portable apparatus, a lock screen;
receiving one of a connection unlock pattern and a unlock pattern, which is input to the lock screen; and
in response to the connection unlock pattern being received, connecting the portable apparatus to the external apparatus that corresponds to the connection unlock pattern, and
in response to the unlock pattern being received, unlocking the lock screen.

17. The method of claim 1, wherein the connecting comprises connecting the portable apparatus to the external apparatus from among a plurality of external apparatuses available to the portable device according to the connection unlock pattern.
